(19) United States
(12) Patent Application Publication
(10) Pub. No.: US 2009/0110440 A1
(43) Pub. Date: Apr. 30, 2009

(54) TONER CARTRIDGE

(75) Inventors: Toru HOMMA, Yokohama-shi (JP); Hiroshi HASHIDUME, Hino-shi (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/255,559

(22) Filed: Oct. 21, 2008

Related U.S. Application Data
(60) Provisional application No. 60/983,520, filed on Oct. 29, 2007.
(60) Provisional application No. 60/983,523, filed on Oct. 29, 2007.
(60) Provisional application No. 60/983,891, filed on Oct. 30, 2007.
(60) Provisional application No. 60/983,893, filed on Oct. 30, 2007.

(51) Int. Cl. G03G 15/08

(52) U.S. Cl. 399/262

(57) ABSTRACT

A toner cartridge includes a recording unit that records a deterioration table in which a reference value of a deterioration degree is specified for each of constituent members and a load characteristic table in which the deterioration degree corresponding to an operation state of an image forming apparatus in which the toner cartridge is inserted is specified, a transmitting and receiving unit that performs transmission and reception with the image forming apparatus in which the toner cartridge is inserted, a deterioration counter that extracts the deterioration degree for each of the constituent members from the load characteristic table according to an operation state of the image forming apparatus and counts the deterioration degree for each of the constituent members, and a control unit that compares the deterioration degree counted by the deterioration counter and the reference value specified in the deterioration table.

### CROSS-REFERENCE TO RELATED APPLICATION

This application is based upon and claims the benefit of priority from prior application No. 60/983,520, filed Oct. 29, 2007, application No. 60/983,523, filed Oct. 29, 2007, application No. 60/983,891, filed Oct. 30, 2007, and application No. 60/983,893, filed Oct. 30, 2007, the entire contents of which are incorporated herein by reference.

### TECHNICAL FIELD

The present invention relates to a deterioration management technique for toner cartridges.

### BACKGROUND

The reproduction of toner cartridges is discussed for a reduction in environmental loads. There is a growing sense of crisis about energy problems and environmental disruption due to global warming. Therefore, various measures are taken in the electrophotographic field because of the necessity of recycling. As the reproduction in the electrophotographic field, a toner cartridge is disassembled and cleaned and materials required to be replaced are visually determined to reproduce the toner cartridge. The visual determination depends on long experiences. A recycled toner cartridge may be lower in quality than a new one. In some case, there is a fear about a trouble caused by the recycled toner cartridge.

U.S. Pat. No. 6,487,377 is known as a patent that discloses such a related art in the field of the reproduction of an image forming apparatus main body. U.S. Pat. No. 6,487,377 discloses a system that manages information concerning components using a computer and determines whether collected components can be recycled.

However, when the related art is applied to an electrophotographic cartridge, there is a disadvantage that the related art takes into account only the factor of the number of times of recycle but does not take into account effective loads corresponding to a state in each time of recycle.

A toner cartridge is formed of various materials such as metal components and resin materials such as plastic. However, for example, when the toner cartridge is recycled, since a user does not know information concerning materials forming the toner cartridge, it is difficult for the user to check safety in recycling the toner cartridge.

There is also known a toner cartridge having a configuration for informing a user that a replacement period is approaching. However, it depends on the user's decision how to handle the toner cartridge in which a toner or ink is exhausted. The user needs to check a collection route for the toner cartridge every time the user disposes of the toner cartridge.

To secure qualities of consumables until the consumables are delivered to customers, every effort is made to maintain the qualities through improvement of transportation routes and improvement of storage environments. However, it is unknown if materials are actually managed as decided in transportation management and storage management.

Therefore, deterioration of consumables is said to proceed at speed of a function of temperature and time. It is appropriate to determine the deterioration after accurately obtaining information concerning the temperature and the time. However, in the management method in the past, practically, it is impossible to manage the consumables on the basis of the information. Eventually, it is difficult to appropriately determine the deterioration of the respective consumables.

Therefore, it is an object of the present invention to provide a toner cartridge, a degree of deterioration of which can be accurately grasped.

### SUMMARY

According to one aspect of the present invention, there is provided a toner cartridge including a recording unit that records a deterioration table in which a reference value of a deterioration degree is specified for each of constituent members and a load characteristic table in which the deterioration degree corresponding to an operation state of an image forming apparatus in which the toner cartridge is inserted is specified, a transmitting and receiving unit that performs transmission and reception with the image forming apparatus in which the toner cartridge is inserted, a deterioration counter that extracts the deterioration degree for each of the constituent members from the load characteristic table according to an operation state of the image forming apparatus and counts the deterioration degree for each of the constituent members, and a control unit that compares the deterioration degree counted by the deterioration counter and the reference value specified in the deterioration table.

### DESCRIPTION OF THE DRAWINGS

FIG. 1 is a schematic diagram of an external appearance of an image forming apparatus to which a toner cartridge according to an embodiment is applied;

FIG. 2 is a schematic diagram showing an external view of toner cartridges inserted in the image forming apparatus according to the embodiment;

FIG. 3 is a block diagram of the toner cartridge and the image forming apparatus according to the embodiment;

FIG. 4 is a diagram of a load characteristic table recorded in a memory of the toner cartridge according to the embodiment; and

FIG. 5 is a diagram of a load characteristic table recorded in the memory of the toner cartridge according to the embodiment.

### DETAILED DESCRIPTION

Embodiments are explained below with reference to the accompanying drawings.

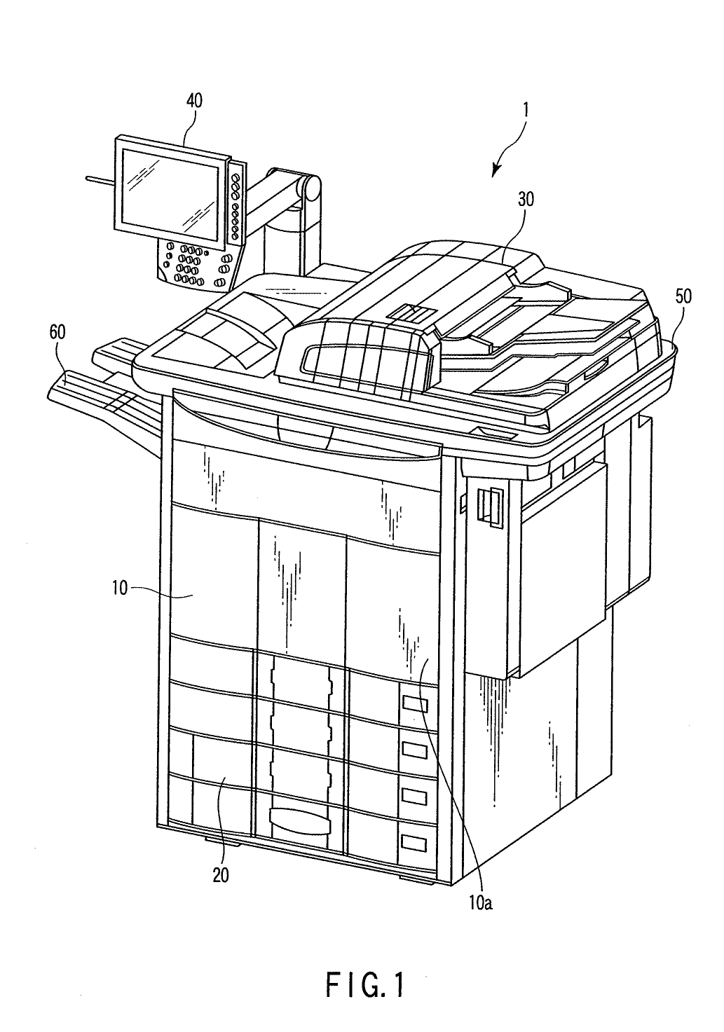

FIG. 1 is a perspective view of an external appearance of an image forming apparatus 1 according to an embodiment. The image forming apparatus 1 is a quadruple tandem color copying machine. The image forming apparatus 1 includes an image forming unit 10 for outputting image information as an output image called hard copy or printout, a sheet feeding unit 20 that can feed a sheet (an output medium) of an arbitrary size used for image output to the image forming unit 10, and a scanner 50 that captures image information, from which an image is formed in the image forming unit 10, as image data from an object on which the image information is held (hereinafter referred to as original). Above the image forming unit 10, an automatic document feeder 30 that discharges, when the original is a sheet-like original, after scanning the image information with the scanner 50, the scanned original from a scanning position to a discharge position and guides the next original to the scanning position is provided. An instruction inputting unit for instructing the start of image formation in the image forming unit 10 and the start for scanning the image information of the original by the scanner 50, i.e., a display unit 40 as a control panel is provided in the image forming apparatus 1.

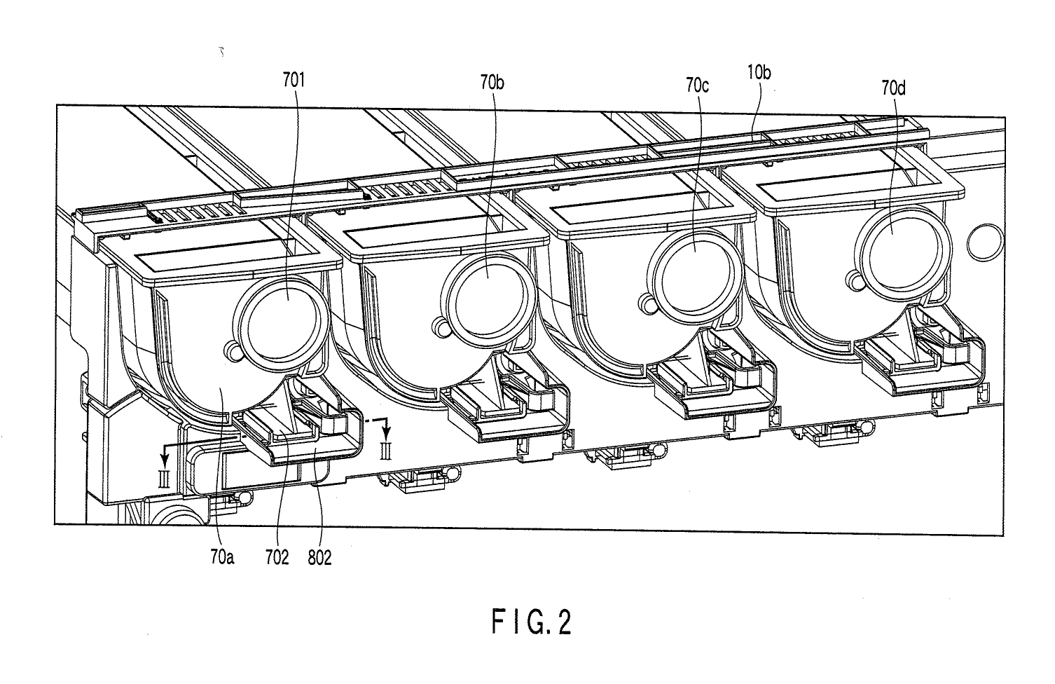

FIG. 2 is a diagram of toner cartridges 70 inserted in the image forming apparatus 1 shown in FIG. 1 viewed from a front side of the image forming apparatus 1. As shown in FIG. 1, a cover 10a is openably and closeably provided on a front side of the image forming unit 10. When the cover 10a is opened, toner cartridges 70a, 70b, 70c, and 70d provided in parallel on an upper side of the image forming unit 10 are seen. The cover 10a is provided on the image forming unit 10 pivotably around one side end on the image forming unit 10.

The toner cartridges 70a, 70b, 70c, and 70d are detachably attachable to a cartridge holding mechanism 10b provided on the front side of the image forming unit 10. The toner cartridges 70a, 70b, 70c, and 70d supply toners of yellow, magenta, cyan, and black, respectively. As shown in FIG. 2, a cap 701 that closes an opening for supplying the toner into the toner cartridge 70a and a supply unit 702 that supplies the toner to the first toner cartridge 70a are provided on the front side of the image forming apparatus 1.

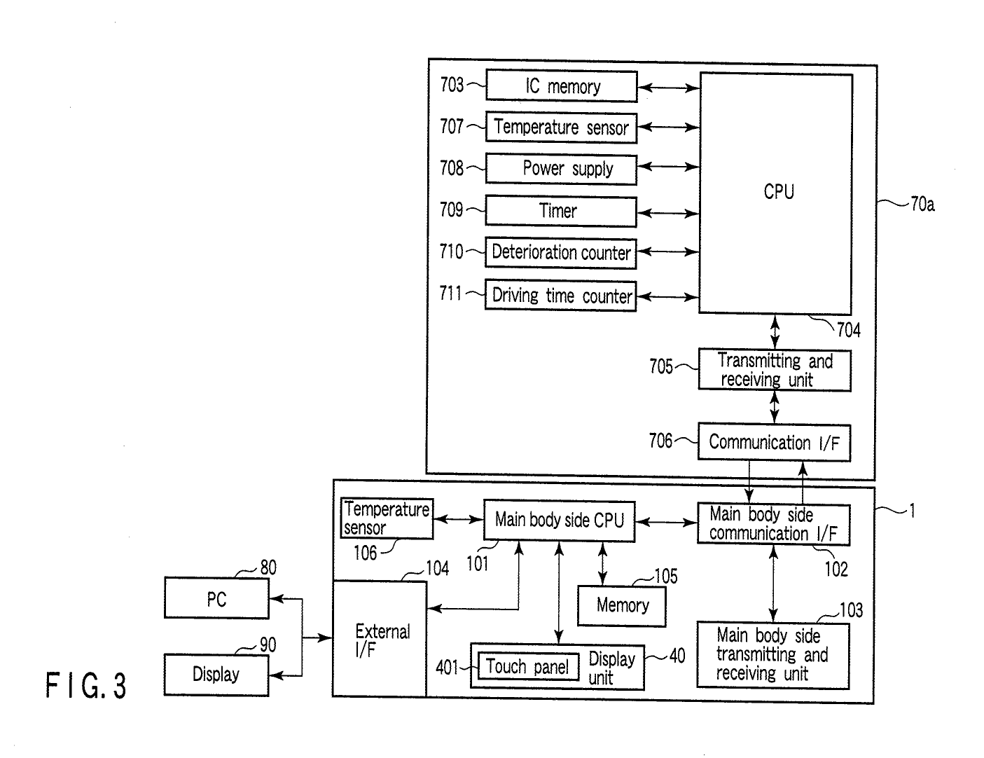

FIG. 3 is a block diagram of control systems in the toner cartridge 70a and the image forming apparatus. The control system in the toner cartridge 70a is explained below. However, the same holds true for the toner cartridges 70b, 70c, and 70d.

The toner cartridge 70a includes a memory 703, a CPU 704, a transmitting and receiving unit 705, a communication I/F 706, a temperature sensor 707, a power supply 708, a timer 709, a deterioration counter 710, and a driving time counter 711.

The memory 703 records safety information concerning the toner filled in the toner cartridge 70a, material characteristic information of components configuring the toner cartridge 70a, return destination list information, genuine component information, accumulation time by temperature zone information, load characteristic table information, and deterioration table information. As the memory 703, for example, a general-purpose IC chip is used.

The safety information concerning the toner includes, for example, CAS numbers and mutagenicity test results. The material characteristic information of the components is information such as component material names, CAS numbers of materials, environmental data such as inflammability and a CO2 discharge amount (LCA (Life Cycle Assessment)), toxicity, volatility, and irritability. The return destination list information is information concerning a return destination list of agents or collection destinations by country and by region for the toner cartridge 70a. The accumulation time by temperature zone information is reference value information of accumulation time calculated by adding up elapsed time in each of temperature zones. The load characteristic table information is information indicating a deterioration characteristic peculiar to the toner cartridge 70a. The deterioration table information is information in which a deterioration degree for each of members configuring the toner cartridge 70a is updated and recorded.

The CPU 704 controls operations of the respective units. The CPU 704 may be configured by a normal PC board or may be configured by an organic semiconductor.

The transmitting and receiving unit 705 transmits and receives information to and from the image forming apparatus 1 via the communication I/F 706. The temperature sensor 707 is, for example, a thermistor and measures the temperature of the toner cartridge 70a. The power supply 708 is, for example, a LI type button battery. The power supply 708 is used as a driving source for the respective units provided in the toner cartridge 70a. The timer 709 starts counting at predetermined timing using the CPU 704. The deterioration counter 710 counts a deterioration degree for each of the constituent members of the toner cartridge 70a. The driving time counter 711 counts time in which the toner cartridge 70a operates in the image forming apparatus.

The image forming apparatus 1 includes a main body side CPU 101, a main body side communication I/F 102, a main body side transmitting and receiving unit 103, a display unit 40, an external I/F 104, a main body side memory 105, and a temperature sensor 106.

The main body side CPU 101 controls the respective units in the image forming apparatus 1. The main body side transmitting and receiving unit 103 controls transmission and reception of information to and from the toner cartridge 70a via the main body side communication I/F 102. The external I/F 104 is an interface for connection with an external terminal. The main body side memory 105 records various kinds of information. The temperature sensor 106 is provided in a predetermined place of the image forming apparatus 1 and measures the temperature in the image forming apparatus 1.

The detection of a deterioration degree of the toner cartridge 70a at the time when the toner cartridge 70a is inserted in the image forming apparatus 1 is explained.

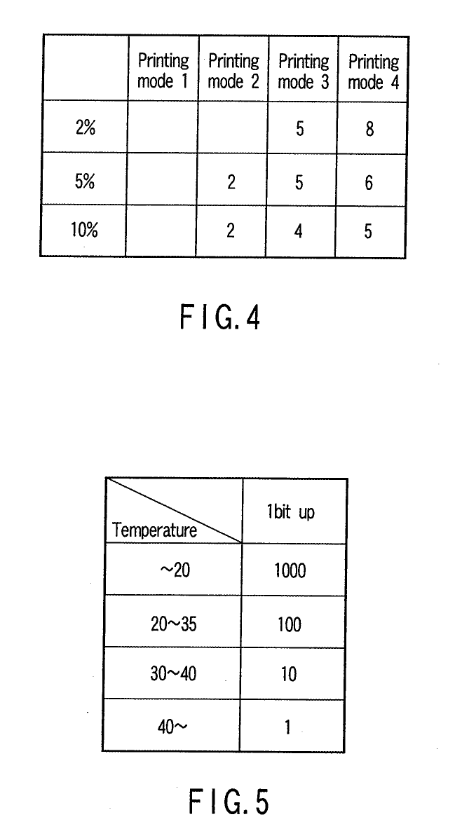

When the main body side CPU 101 determines that the toner cartridge 70a is inserted, the main body side CPU 101 determines whether data can be read in a predetermined area of the memory 703. When it is determined that the data can be read in the predetermined area, the main body side CPU 101 calculates a load from the load characteristic table information acquired from the toner cartridge 70a. FIG. 4 is a diagram of an example of a load characteristic table including printing modes and printing ratios. Values corresponding to the printing modes and the printing ratios are specified. FIG. 5 is a diagram of a load characteristic table in which values corresponding to temperatures detected by the temperature sensor 106 provided in the image forming apparatus 1 are specified. When a value specified in the load characteristic table is large, this means that the constituent members of the toner cartridge 70a are less easily deteriorated.

In other words, as an operation state of the image forming apparatus 1 and an external factor are severer, the constituent members of the toner cartridge 70a is more easily deteriorated. When the main body side CPU 101 determines that time or the number of times same as a value specified in the load characteristic table is exceeded, the main body side CPU 101 counts up a deterioration degree by 1. The main body side CPU 101 calculates a deterioration degree caused by the operation of the image forming apparatus 1 using the load characteristic table information and driving time of the image forming apparatus 1 as variables.

The main body side CPU 101 transmits the calculated deterioration degree to the toner cartridge 70a. The deterioration counter 710 of the toner cartridge 70a counts a deterioration degree for each of the constituent members configuring the toner cartridge 70a. Every time the main body side CPU 101 calculates a degree of deterioration caused by the operation of the image forming apparatus 1 and transmits the deterioration degree to the toner cartridge 70a, the deterioration counter 710 adds up and updates the deterioration degree for each of the constituent members.

As the values specified in the load characteristic tables shown in FIGS. 4 and 5, a different value is specified for each of the constituent members. In other words, a different load characteristic table is recorded for each of the members configuring the toner cartridge 70a in the memory 703. Therefore, when the toner cartridge 70a is empty, the deterioration counter 710 counts a different value of a deterioration degree for each of the constituent members of the toner cartridge 70a.

The CPU 704 compares the deterioration table information recorded in the memory 703 and a deterioration degree counted by the deterioration counter 710. When the CPU 704 determines that the deterioration degree counted by the deterioration counter 710 is equal to or larger than the deterioration degree specified in the deterioration table, the CPU 704 determines that a member corresponding to the deterioration degree is required to be replaced. The CPU 704 transmits information concerning the constituent member required to be replaced and information indicating the necessity of replacement to the image forming apparatus 1 via the communication I/F 706. The image forming apparatus 1 displays, on the basis of the received information, the information on the display unit 40.

With the configuration described above, since a user can replace each of the constituent members of the toner cartridge 70a, the toner cartridge 70a can be recycled at low cost.

When a member of the toner cartridge 70a is replaced by the user, the toner cartridge 70a is connected to a reproduction tester. The deterioration table recorded in the memory 703 and deterioration degrees added up by the deterioration counter 710 are read out. The user replaces a member, a deterioration degree of which added up by the deterioration counter 710 is equal to or higher than a deterioration degree specified in the deterioration table. After replacing the member, the user resets the deterioration counter 710 and the driving time counter 711 for the member of the toner cartridge 70a.

Thereafter, when the member is replaced and the toner cartridge 70a is inserted into the image forming apparatus 1, the deterioration counter 710 adds up and counts a deterioration degree again according to the operation of the image forming apparatus 1.

When the toner cartridge 70a is inserted into the image forming apparatus 1, if the main body side CPU 101 cannot read out data from the memory 703, the main body side CPU 101 stops the operation by the deterioration counter 710 in order to prevent an improper operation.

In the toner cartridge 70a, each of the constituent members is deteriorated at different timing. With the configuration explained above, the user can grasp timing of deterioration for each of the constituent members of the toner cartridge 70a. Therefore, the user can replace necessary minimum constituent members of the toner cartridge 70a at suitable timing. As a result, it is possible to provide the user with the recycled toner cartridge 70a that is high in quality, low in price, and environment-friendly.

When the toner cartridge 70a is inserted in the image forming apparatus 1, when the user operates a touch panel 401 of the display unit 40, the main body side CPU 101 requests the toner cartridge 70a to transfer the information recorded in the memory 703. The main body side CPU 101 controls the display unit 40 to display the information transferred from the toner cartridge 70a.

Therefore, the user can check the information received from the toner cartridge 70a on the display unit 40. In other words, the user can check safety of treatment of powder, lead-free, and the like from safety information of a toner. The main body side CPU 101 can also control a PC 80 and a display 90 as external terminals connected to the external I/F 104 of the image forming apparatus 1 to display the information or data recorded in the memory 703. When the return destination list information is displayed on the display unit 40, the user can select a convenient agent. Therefore, the user can easily find a return destination of the toner cartridge 70a. Information concerning the return destination once selected by the user is stored in the main body side memory 105. Since the user can request to read out the return destination of the toner cartridge 70a from the main body side memory 105, convenience is improved.

Consequently, since the user can easily grasp the return destination of the toner cartridge 70a in which a toner, ink, or the like is exhausted, it is possible to smoothly replace and collect the toner cartridge 70a.

Prevention of deterioration due to the temperature of the toner cartridge 70a is explained as another embodiment.

The CPU 704 controls the timer 709 to count elapsed time for each of temperature zones (e.g., temperature width of 2° C.) from temperature information measured by the temperature sensor 707. In other words, this embodiment takes into account, as a factor of deterioration of the toner cartridge 70a, temperature that changes according to outside temperature and an operation environment in the image forming apparatus 1. The CPU 704 counts elapsed time in units of minute. The CPU 704 calculates elapsed time for each of the temperature zones. The CPU 704 records matrix data of each of the temperature zones and the elapsed time in the memory 703. In the matrix data, the elapsed time for each of the temperature zones is accumulated and updated and recorded as accumulated time.

The main body side CPU 101 determines deterioration of the toner cartridge 70a by comparing accumulated time by temperature zone information recorded in the memory 703 and the matrix data of the temperature zones and the accumulated time.

The accumulated time by temperature zone information is a peculiar characteristic determined for each of the toner cartridges according to a material, a size, a filled toner, and the like of the toner cartridge 70a in advance. In other words, the accumulated time by temperature zone information is a reference value corresponding to the accumulated time for each of the temperature zones. When the accumulated time is smaller than the reference value, the toner cartridge 70a is not deteriorated. On the other hand, when the accumulated time is equal to or larger than the reference value, the toner cartridge 70a is deteriorated.

When the main body side CPU 101 determines that the toner cartridge 70a is deteriorated, the main body side CPU 101 acquires the return destination list information from the memory 703 of the toner cartridge 70a and displays a return destination of the toner cartridge 70a on the display unit 40. When one return destination is set as the return destination list information, the main body side CPU 101 informs, via the external I/F 104, the return destination that collection of the toner cartridge 70a is desired.

When the main body side CPU 101 is attached to the image forming apparatus 1, if it is judged that the toner cartridge 70a that cannot read the memory 703 is inserted, the main body side CPU 101 does not actuate the functions explained above. This is because the main body side CPU 101 malfunctions when the accumulated time by temperature zone information of the toner cartridge 70a cannot be accurately acquired.

By adopting such a configuration, it is possible not only to provide the user with the appropriate toner cartridge 70a but also to take measures against abnormality without troubling the user even when the constituent members are deteriorated.

When the user inputs, on the operation panel 401 of the display unit 40, a request for information desired by the user among the information recorded in the memory 703, the main body side CPU 101 performs control to display information corresponding to the request inputted on the operation panel 401. When the user inputs a request for desired information on the operation panel 401, authentication confirmation may be executed on the operation panel 401.

With the configuration described above, since the information recorded in the memory 701 of the toner cartridge 70a is displayed on the display unit 40, the user can easily check safety of the constituent members configuring the toner cartridge 70a. Therefore, the user can safely use the toner cartridge 70a. Consequently, when the toner cartridge 70a is recycled, the user can surely recycle the toner cartridge 70a according to materials and the like of the constituent members.

What is claimed is:

1. A toner cartridge comprising:
a recording unit that records a deterioration table in which a reference value of a deterioration degree is specified for each of constituent members and a load characteristic table in which a condition corresponding to a state of an image forming apparatus in which the toner cartridge is inserted is specified;
a transmitting and receiving unit that performs transmission and reception with the image forming apparatus in which the toner cartridge is inserted;
a deterioration counter that counts up the deterioration degree for each of the constituent members when the condition specified in the load characteristic table according to a state of the image forming apparatus is satisfied; and
a control unit that compares the deterioration degree counted by the deterioration counter and the reference value specified in the deterioration table.

2. The toner cartridge of claim 1, wherein the control unit determines, when it is determined that the deterioration degree counted by the deterioration counter is equal to or higher than the reference value specified in the deterioration table for a specific constituent member, that the specific constituent member is required to be replaced.

3. The toner cartridge of claim 2, wherein
the deterioration counter counts the deterioration degree when it is judged that readout from the recording unit by the image forming apparatus in which the toner cartridge is inserted is possible.

4. The toner cartridge of claim 3, wherein, in the load characteristic table, a different condition is specified for each of the constituent members.

5. The toner cartridge of claim 4, wherein, when the specific constituent member determined by the control unit as being required to be replaced is replaced, the deterioration counter resets the deterioration degree corresponding to the replaced specific constituent member.

6. The toner cartridge of claim 5, wherein the recording unit records return destination information.

7. The toner cartridge of claim 6, wherein the transmitting and receiving unit transmits the return destination information according to a request from the image forming apparatus in which the toner cartridge is inserted.

8. The toner cartridge of claim 7, wherein the transmitting and receiving unit transmits, on the basis of the return destination information, to the effect that the replacement is necessary to a return destination of the toner cartridge via an external network.

9. The toner cartridge of claim 8, wherein the recording unit records information concerning the constituent members.

10. A toner cartridge comprising:
a recording unit that records deterioration information in which a reference value indicating a deterioration degree is specified;
a transmitting and receiving unit that performs transmission and reception with an image forming apparatus in which the toner cartridge is inserted;
a temperature sensor that measures temperature;
a timer that measures elapsed time; and
a control unit that measures elapsed time using the timer for each of temperature zones in which the temperature measured by the temperature sensor is set at a predetermined interval and records measurement data obtained by adding up the elapsed time in each of the temperature zones in the recording unit.

11. The toner cartridge of claim 10, wherein, in the deterioration information, a threshold of accumulated elapsed time for each of the temperature zones is specified.

12. The toner cartridge of claim 11, wherein the control unit determines that the replacement is necessary when it is judged that the elapsed time of the measurement data is equal to or larger than the threshold specified in the deterioration information.

13. The toner cartridge of claim 12, wherein
the control unit measures the elapsed time for each of the temperature zones when it is judged that readout from the recording unit by the image forming apparatus in which the toner cartridge is inserted is possible.

14. The toner cartridge of claim 13, wherein the recording unit records return destination information.

15. The toner cartridge of claim 14, wherein the transmitting and receiving unit transmits, on the basis of the return destination information, to the effect that the replacement is necessary.

16. A toner cartridge management method applied to a toner cartridge including a recording unit that records a deterioration table in which a reference value of a deterioration degree is specified for each of constituent members and a load characteristic table in which a condition corresponding to a state of an image forming apparatus in which the toner cartridge is inserted is specified, the method comprising:
determining whether the condition for each of the constituent members is satisfied from the load characteristic table according to a state of the image forming apparatus;
counting up the deterioration degree for each of the constituent members; and
comparing the deterioration degree counted by the deterioration counter and the reference value specified in the deterioration table.

17. The method of claim 16, further comprising determining, when it is determined that the counted deterioration degree is equal to or higher than the reference value specified in the deterioration table for a specific constituent member, that the specific constituent member is required to be replaced.

18. The method of claim 17, further comprising, when it is judged that readout from the recording unit by the image forming apparatus in which the toner cartridge is inserted is possible, counting the deterioration degree.

19. The method of claim 18, further comprising, when the specific constituent member determined as being required to be replaced is replaced, resetting the deterioration degree corresponding to the replaced specific constituent member.

20. The method of claim 19, further comprising, when it is determined that the specific constituent member is required to be replaced, transmitting to that effect.
